(19) United States
(12) Patent Application Publication
(10) Pub. No.: US 2010/0226576 A1
(43) Pub. Date: Sep. 9, 2010

(54) CARD-COUNTING DEVICE

(75) Inventors: Rachid Harba, La Ferte Saint Aubin (FR); Benoit Berthe, Orleans (FR); Dominique Perdoux, Mardie (FR); Benjamin Tourne, Orleans (FR)

Correspondence Address: HAMRE, SCHUMANN, MUELLER & LARSON, P.C., P.O. BOX 2902, MINNEAPOLIS, MN, 55402-0902, US

(73) Assignee: DATACARD CORPORATION, Minnetonka, MN (US)

(21) Appl. No.: 12/597,678

(22) PCT Filed: Apr. 23, 2008
(86) PCT No.: PCT/FR08/00585

§ 371 Date: Apr. 16, 2010

(30) Foreign Application Priority Data
Apr. 26, 2007 (FR) 0703031

(51) Int. Cl. G06K 9/46

(52) U.S. Cl. 382/194

(57) ABSTRACT

The device makes it possible to count series of products that are not very thick, stacked side by side, in a determined direction in a retention mechanism. The device includes a lighting mechanism producing one or more light beams covering the whole length of the stack, a detection mechanism with photosensitive elements and including an optical device, making it possible to focus light rays reflected by the stack, a processing mechanism receiving signals originating from the detection circuit, extracting light levels from these signals in correlation with a dimension of stack thickness expressed in pixels, and computing the number of products by determining the repetition of a pattern representative of a product in a noise-free signal resulting from a conversion of the signals received. A Fourier transform is respectively applied to correlation and bicorrelation functions of the signal in order to find a periodic pattern representative of a product if necessary to the nearest phase shift.

The invention concerns the field of equipment for counting thin products stacked side by side in small series. More particularly, it concerns counting, in an automated fashion and at a good rate, the number of thin products contained in a batch of small series.

There exists counting equipment as described in the patent FR 2 718 550 entitled “Product-counting device”. This device enables large series of thin products stacked side by side to be counted.

Typically, brightness is tested by the saturation of the signal, supplied by a sensor, and if there is saturation counting is not carried out and the counting system produces a “no product found” signal. If there is no saturation, the counting device counts. The counting device uses an inter-correlation system, in a step of pre-processing of the stored signals. Next, the objects are counted by determining peaks and valleys, in other words local maxima and minima for values representing brightness associated with the pixels, and the number of objects counted is stored. The device carries out a plurality of countings, which are each stored, and it is only at the end of this plurality of countings that the device constructs a histogram of the results and seeks whether a value corresponds to a success rate stored.

However, this equipment is not adapted to the automatic processing of small series since it does not make it possible to count the number of elements in small series in a automated fashion, at a good rate. The counting of thin products generally fits in a processing chain before, for example, physical or software personalisation operations or packaging operations. Often the counting of small series of thin products, such as series of personalisable cards of around fifteen elements, is carried by hand, this counting means giving good efficiency. There therefore exists a requirement for a suitable device having a rate making it possible to avoid counting of small series by hand.

The object of the present invention is therefore to mitigate one or more drawbacks of the prior art by creating a device for counting, in an automated fashion, the number of thin products produced in small series, at a good rate.

This objective is achieved by virtue of a device for counting series of thin products, stacked side by side, in a given direction in a holding means, the stacked thin products all having identical thicknesses and constituting a stack, the device comprising at least:
a means of illuminating the stack producing one or more light beams covering at least the entire length of the stack,
a detection means comprising at least one detection circuit, comprising a plurality of photosensitive elements, and at least one optical device associated with the detection circuit, for focusing light rays reflected by the stack.
storage means,

characterised in that it comprises processing means receiving signals coming from the detection circuit or circuits, able to extract from these signals brightness levels in correlation with a dimension along the stacking axis expressed in pixels, the processing means generating a given signal x(n) corresponding to the signals received and including:
extraction means for extracting, from the given signal x(n), a pattern representing a thin product; and
calculation means for calculating the number of thin products, by an intercorrelation of the given signal with the extracted pattern, in order to determine an intercorrelation signal corresponding to the number of patterns present and corresponding to the number of thin products in the stack.

Thus is it advantageously made possible, after an estimation of the pattern representing a card or other thin product, to find precisely the number of times that the pattern is present in the acquired signal: whenever this pattern is present in the signal, this corresponds to a card. A reliable count can be ensured for cards in a stack in a pile, even when there are certain stacking irregularities in the pile (spacing between two non-touching cards for example, a card aslant in the stack, etc).

According to another particularity, the processing means also comprise:
pre-processing means for effecting a Fourier transformation for supplying from the signals received a transformed signal revealing harmonics and for then determining the characteristics of a filtering means for filtering the transformed signal with preservation of at least one harmonic;
   said given signal x(n) being a filtered signal resulting from the pre-processing.

According to another particularity, the pre-processing means comprise reconstitution means effect an inverse Fourier transformation on a filtered transformed signal supplied by said filtering means in order to deliver a pre-processed signal corresponding to the given signal.

According to another particularity, the extraction means are arranged to extract the pattern representing a thin product in the pre-processed signal.

According to another particularity, the means of extracting a pattern comprise:
means of parameterising the thickness determining the first harmonic in the Fourier transform of the signals received and the corresponding thickness of the product,
first calculation means for firstly effecting correlation or convolution functions on the pre-processed signal, and then secondly a Fourier transform calculation for estimating, for each of the frequencies of the Fourier domain, the modulus and argument of the Fourier transform of the pattern representing the periodic signal position corresponding to a thin product; and
second calculation means using an inverse Fourier transformation for calculating said first pattern from results obtained by the first calculation means.

According to another particularity, the first calculation means effect an autocorrelation function c(T) of the filtered signal x(n), defined (for example here in its non-standardised version) by the formula:

$$c ( τ ) = {\sum }_{n = 0}^{N - τ - 1} x ( n ) \cdot x ( n + τ ) , \\ τ = [ 0 , Ep - 1 ]$$

where N is the number of pixels of the image of the filtered signal, x(n), n=[0 . . . N−1] is the de-noised signal and Ep is the thickness of a thin product expressed in pixels.

According to a variant, the first calculation means effect a convolution function conv(T) of the filtered signal on itself, defined by the formula:

$$conv ( τ ) = {\sum }_{n = 0}^{N - r - 1} x ( n ) \cdot x ( τ - n ) , \\ τ = [ 0 , Ep - 1 ]$$

According to another particularity, the first calculation means are arranged to calculate the Fourier transform of the autocorrelation function c(T) of the filtered signal x(n), n=[0 . . . N−1] in order to determine the modulus of the Fourier transform of the periodic signal portion.

According to another particularity, the means of parameterising the thickness of the thin products determine the thickness in pixels and the first calculation means make, for a first half of the frequencies of the plurality of frequencies, in order to determine the argument of the Fourier transform of the period signal portion, an estimation of the values of the argument functions θₘ(f) for f=[0,N−1] with N=(Ep+1)/2 if N is odd or N=Ep/2+1 if N is even,

where θₘ(f) is an odd function and Ep-periodic, Ep being the thickness of a thin product expressed in pixels;
this estimation being performed by n-correlation means of order higher than 2 arranged to:
use a 2-variable operator defined as follows:

$$b ( {τ}_{1} , {τ}_{2} ) = {\sum }_{n}^{ } x ( n ) x ( {τ}_{1} + n ) x ( {τ}_{2} + n )$$

$$for$$

$${τ}_{1} = [ 0 , Ep - 1 ]$$

$$and$$

$${τ}_{2} = [ 0 , Ep - 1 ]$$

where N is the number of pixels of the image of the filtered signal and x(n), n=[0 . . . N−1] is the filtered signal;
calculate the Fourier transform of the n-correlation function b(T1, T2) in the Fourier domain, via a two-dimensional Fourier transformation, in order to obtain a matrix set of linear equations expressing the arguments of the n-correlation function as a function of the arguments of the pattern in the Fourier frequency domain; and
invert the system (matrix inversion, or transposing to a triangular system) in order to take the argument of the n-correlation back to the argument of the pattern in the Fourier domain.

It is possible for example to calculate an invertible matrix for passing from the argument of the transform of the n-correlation function to the argument of the pattern in the Fourier domain. The system can also be resolved by transposing the linear system to a triangular system. Resolution then takes place iteratively.

According to another particularity, the means of parameterising the thickness comprise means of estimating the thickness Ep by means of a first fast Fourier transformation FFT, the estimation means performing:
a calculation of the FFT and its modulus;
location of the fundamental by a search for a maximum on the modulus of the FFT, while in the vector Modulus, of size N, the position of the fundamental is denoted Xfonda;
a calculation of the thickness Ep, taking into account the fact that the position of the fundamental corresponds to a thickness Ep expressed in pixels: Ep=N/Xfonda; and
a rounding of the value found for Ep to the closest integer value.

According to another particularity, filtering means are provided for supplying to the extraction means a filtered de-noised signal, the second calculation means determining a first periodic pattern representing a thin product to within any phase shift.

According to another particularity, the extraction means execute at least one algorithm for processing the de-noised signal in order to determine the signal pattern used for the intercorrelation, the form of the pattern adopted for a series of products being counted being estimated after a comparison between the first periodic pattern detected in the de-noised signal and a reference pattern stored in the storage means.

According to another particularity, the parameterising means associated with the processing means are designed to store the reference position during a counting performed by the counting device with a standard batch of thin products. The reference pattern can also be chosen from a series of standard geometric shapes (crenellation, inverted crenellation, triangle, portion of parabola etc).

According to another particularity, the filtering means is a comb filter configured to eliminate, by filtering, in the received signals, noise and frequencies not corresponding to harmonics, in order to obtain a pre-processed signal in which frequencies distant from the harmonics and potentially corresponding to gaps or spaces between the thin products are eliminated.

According to another particularity, the means of extracting the signal pattern comprise circular adjustment means for avoiding obtaining a pattern offset by phase shift, the circular adjustment means reproducing, from the first pattern, patterns with different phase shifts, the phase shift finally applied being determined by the use of a reference pattern.

According to another particularity, the means of calculating the number of thin products comprise:
means of calculating intercorrelation between the extracted signal pattern and the de-noised signal, making it possible to supply the intercorrelation signal; and
means of counting the patterns in the de-noised signal, by detection of the local maxima of the intercorrelation signal.

According to another particularity, the circular adjustment means comprise:
means of determining, from the first pattern, patterns with different phase shifts;
means of calculating a scalar product used to calculate for the different patterns scalar products with the reference pattern; and
comparison means for determining a maximum among the calculated scalar products, the phase shift applied finally corresponding to the one maximising the scalar product with the reference pattern.

According to another particularity, the processing means generate a vector representing the signals received and effecting a fast Fourier transformation FFT on this vector, the filtering means receiving the fast Fourier transform of this vector and effecting a frequency Fourier filtering after a determination of the harmonics.

According to another particularity, said vector is generated by a program executing a zero-padding method so that said vector corresponds to an increased signal size and groups together a number N_{zp} of signal samples, N_{zp} being a power of 2, the program being provided with an added-zero suppression function, this suppression function being activated to make it possible to obtain the filtered signal after application of the inverse fast Fourier transform IFFT.

According to another particularity, the intercorrelation calculation means calculate the correlation I(n) between the estimated pattern mot(k) of size Ep, and the de-noised signal x(k) of size N, by use of the following formula:

### For

$$n = [ \frac{Ep}{2} … N - \frac{Ep}{2} ] \text{:}$$

$$I ( n ) = {\sum }_{k = 0}^{k = Ep - 1} mot ( k ) \cdot x ( n - \frac{Ep}{2} + k )$$

where n is the number of pixels in the image of the de-noised signal, x(k) the de-noised signal and Ep is the thickness of a thin product expressed in pixels.

According to another particularity, a CIS module (provided with a CIS sensor “contact image sensor”), disposed longitudinally and opposite the stack constitutes the illumination means and the detection means, the CIS module having a length at least equal to that of the stack, or the CIS module effecting movements in the longitudinal direction of the stack facing a zone covering at least the entire length of the stack in several steps.

According to another particularity, the device comprises a plurality of CIS modules, disposed longitudinally and opposite the stack, each CIS module comprising detection means and means of illumination by a flat beam in the given direction, the sum of the lengths of the CIS modules being at least equal to the length of the stack.

According to another particularity, the CIS modules illuminate the stack along an illumination line, each CIS module being inclined at a given angle so that its planar illumination beam encounters this line.

Another aim is the use of a counting system according to the invention to allow adaptations of certain fabrication operations according to the batch and to follow each batch continuously.

This aim is achieved by the use of the counting device by which information is transmitted, via communication means, by the processing means to a processing system, of the personalisation machine type, downstream of a processing chain, the information transmitted comprising the number of thin products calculated by the device for each series constituting the stack and/or information for deriving this number and/or an identifier associated with each series.

According to another particularity, the processing system personalises the products in the series, physical or software personalisation operations to be applied to each element in a series being associated with the information transmitted by the processing means.

An additional object of the invention is to make it possible to use the device for the purpose of personalising chip cards or similar portable objects.

To this end, the invention also relates to a use of the counting device, characterised in that a logic personalisation station, processing a series of thin products comprising an integrated circuit, enables personalisation information for the use for which the product is intended to be entered in the memory of the integrated circuit.

Another aim is to provide a high-performance detection signal processing method making it possible, by a rapid analysis of the signal, to count the numbers of products of the same thickness in a more or less compact stack.

This aim is achieved by a method of processing at least one signal coming from the detection circuit or circuits (of the optical type) of a thin product counting device, characterised in that it comprises:
a step of pre-processing said signal, including a filtering of the signal to produce a filtered signal;
a step of estimating in the filtered signal a pattern representing a thin product;
a step of calculating intercorrelation information between the estimated pattern and the filtered signal, in order to detect patterns present in the filtered signal; and
a step of signalling, by an interface of the device, information representing the number of thin products processed by the device, by counting the maxima detected in the intercorrelation information.

According to another particularity, the filtering during the step of pre-processing said signal is performed after a Fourier transformation and by the use of a comb filter. The filtering can also be done by implanting a conventional finite or non-finite pulse response filter.

According to another particularity, the method comprises a step of converting the signal, before filtering, into data representing brightness levels in correlation with a stack thickness dimension expressed in pixels, the estimation step defining a first periodic pattern representing a thin product to within any phase shift, and then using a reference pattern for effecting a circular adjustment for obtaining a second estimated pattern without phase shift.

According to another particularity, the signalling step comprises a display of a number of chip cards to be processed by a chip card personalisation machine and/or a transmission of information representing this number to the personalisation machine.

An additional objective of the invention is to propose a program executable by a computer system for controlling the processing in a suitable fashion for obtaining rapid and reliable counting.

To this end, the invention concerns a computer program directly loadable into the memory of a computer and including computer codes for controlling the steps of the method when said program is executed on a computer, said program thus enabling series of thin products in a stack to be counted.

The invention, the characteristics thereof and advantages thereof will emerge more clearly from a reading of the description given with reference to the figures referenced below:

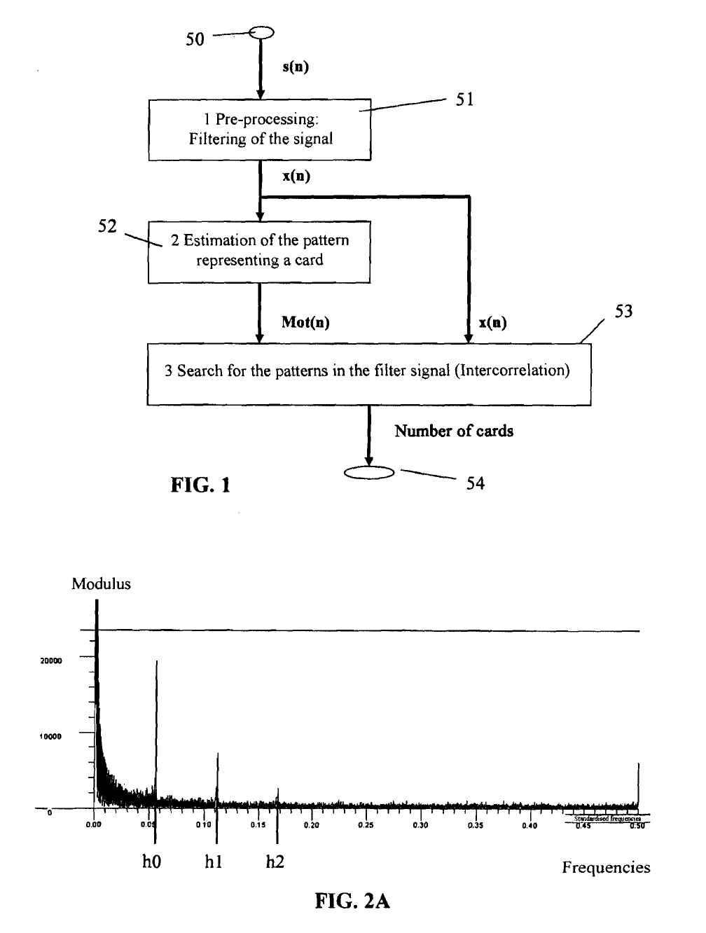

FIG. 1 shows a logic diagram of steps that summarises the general course of a counting method according to the invention.

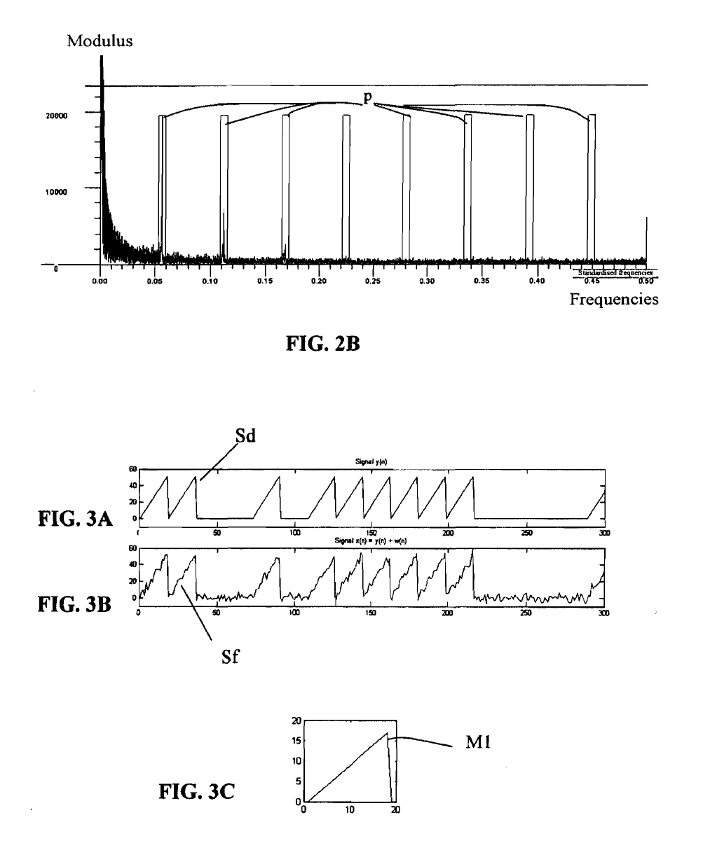

FIGS. 2A and 2B show an example of graphs of the amplitude of a fast Fourier transform associated with the signals issued from the photosensitive elements, and illustrate respectively the decomposition of the signal into harmonics and the Fourier pre-filtering for seeking patterns.

FIGS. 3A and 3B show respectively a useful (de-noised) signal and the corresponding signal including the noise.

FIG. 3C illustrates a modelling of the pattern to be sought in the de-noised signal.

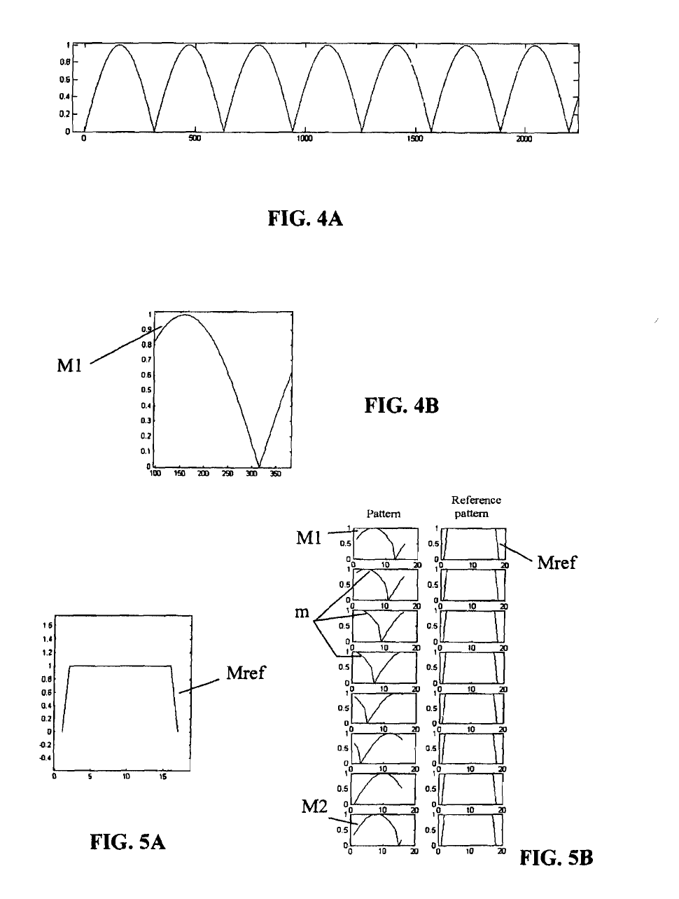

FIGS. 4A and 4B illustrate the possible presence of a phase shift.

FIGS. 5A and 5B illustrate respectively a reference pattern used in the circular adjustment, and an example of the performance of a circular adjustment.

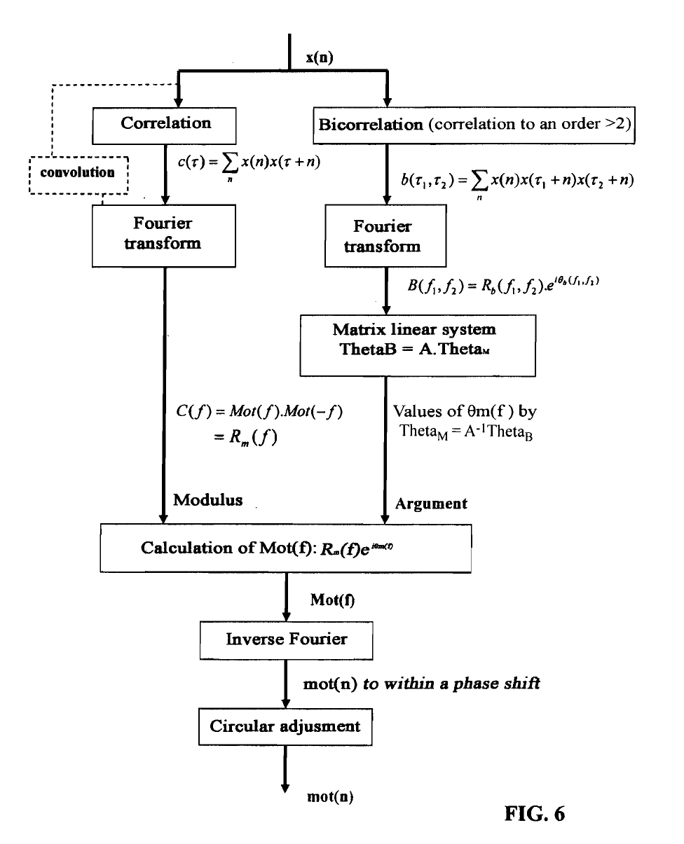

FIG. 6 shows a general diagram of a search for the optimum pattern according to one embodiment of the invention.

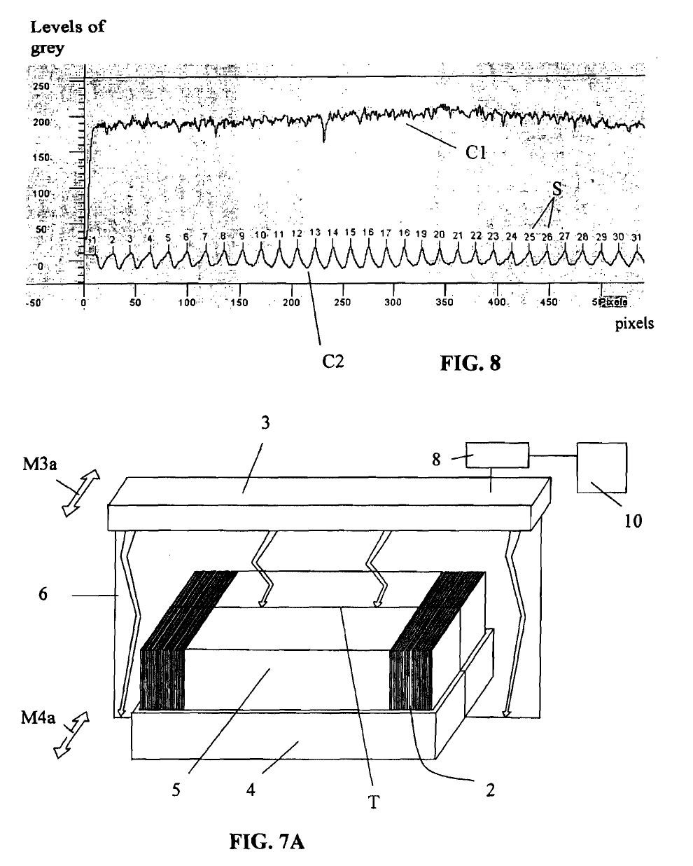

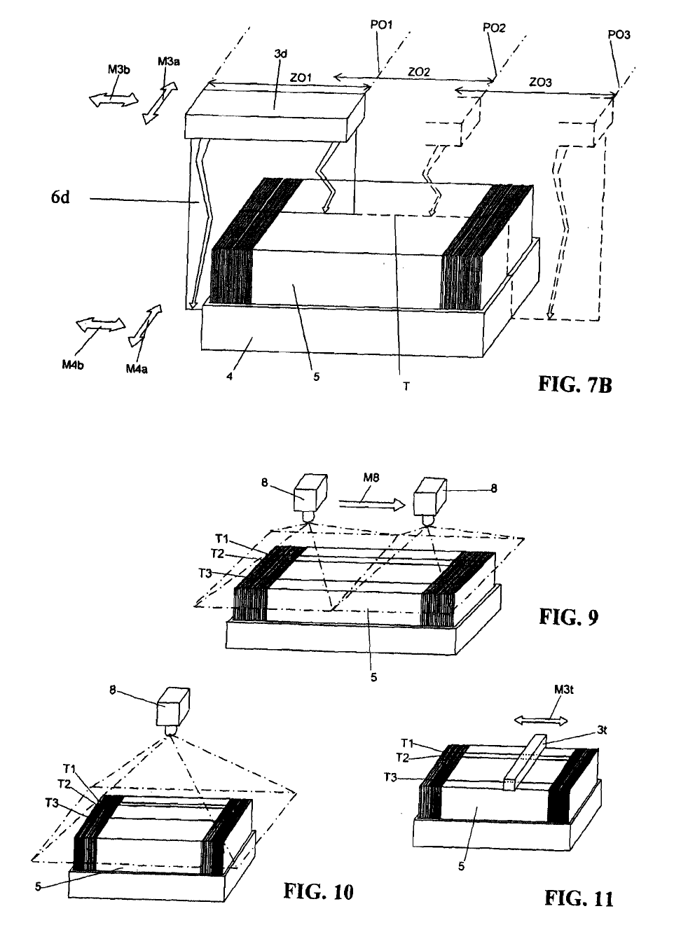

FIG. 7A is a view in perspective showing an example of a counting device comprising a CIS module covering the entire stack.

FIG. 7B shows a view in perspective showing an example of a counting device comprising a CIS module covering the entire stack by longitudinal movements.

FIG. 8 illustrates the intercorrelation between the pre-processed signal and the estimated pattern.

FIG. 9 shows an example of a counting device comprising a transverse CIS module effecting a longitudinal movement.

FIG. 10 shows an example of a counting device comprising a CCD matrix camera performing longitudinal analyses along several longitudinal lines.

FIG. 11 shows an example of a counting device comprising a CCD matrix camera performing one or more longitudinal analyses by a movement in the longitudinal direction.

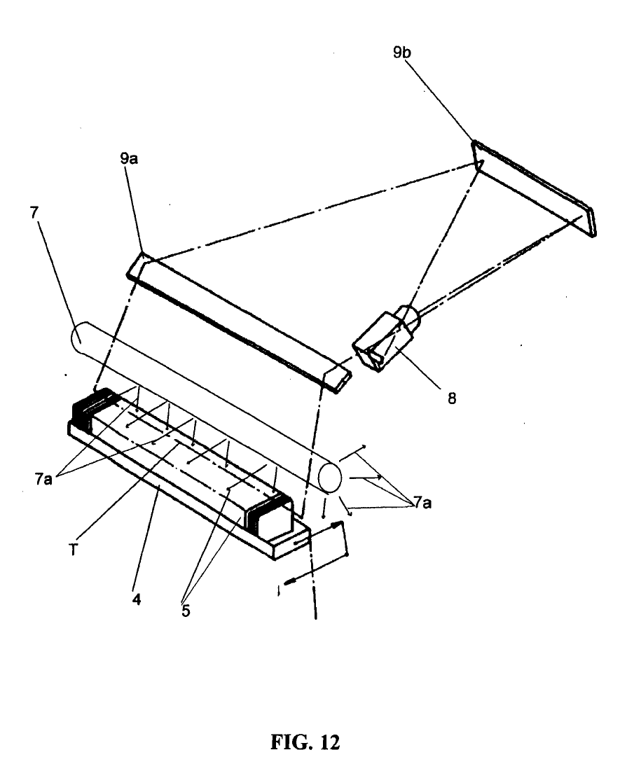

FIG. 12 is a perspective view showing an example of a counting device comprising a CCD camera.

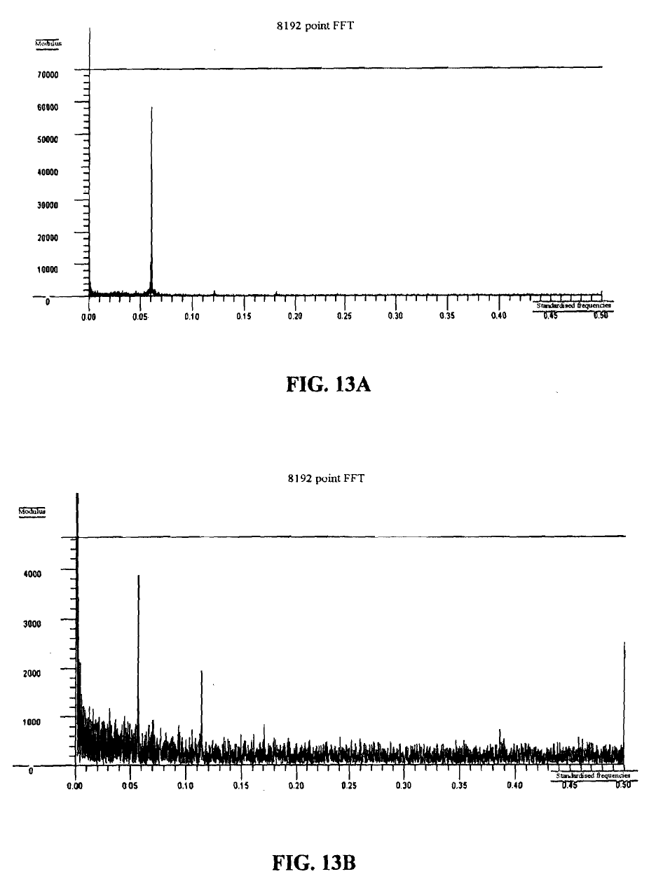

FIG. 13A illustrates a signal obtained with better contrast than that in FIG. 2A. FIG. 13B illustrates a similar signal obtained with poor contrast compared with the one obtained in FIG. 2A.

The invention will now be described with reference to FIGS. 1 to 17. FIGS. 7A and 7B show a counting device comprising a CIS module (3). One or more CIS modules (3, 3d) can be disposed longitudinally. A CIS module (3, 3d) comprises integrated illumination means, photosensitive cell and optical focusing device. FIG. 12 shows a counting device comprising an illumination means (7), mirrors (9a, 9b) and a CCD camera (8). Other cameras, of the same type, comprising an optical device and a photosensitive circuit and producing an electrical signal according to the light received can be used.

Focussing the light rays reflected by the stack (5) enables one or more signals to be recovered via at least one detection circuit. These signals are extracted to allow processing, in which it is sought to analyse the variations in the brightness levels in correlation with a stack thickness dimension expressed in pixels. The device enables series of thin products (2), stacked side by side, to be counted by a determination of the repetition of a pattern representing a product (2) in a filtered de-noised signal resulting from a transformation of the signals received. Advantageously, a first Fourier transformation is used before effecting a comb filtering in order to obtain subsequently the de-noised signal. A system based on a Fourier transform and statistics of an order greater than two is used to make it possible to precisely define a periodic pattern representing a thin product to within any phase shift, via a calculation of the argument and the modulus of the signal pattern transformed in the Fourier domain.

For good presentation of the products (2) such as chip cards, facilitating the counting operation, the device can comprise a rectangular carton (4) containing the thin products (2), only the products (2) at the end of the stack (5) being shown in FIGS. 7 to 11. The thin products (2) can be held, non-limitatively, by a transparent shrink film or by shims in abutment on the carton (4). The carton (4) serves non-limitatively as a means of holding the thin products (2).

In another embodiment, a magazine used for processing the thin products (2) is used directly. The stack (5) is illuminated over its entire length, by a flat beam of light rays (6, 6d) produced by the illumination means of a CIS module (3, 3d) or by a diode illumination means the rays of which are focused on a plane by an optical device. The flat beam (6, 6d) projected against the stack (5) produces a light line (T). The line (T) is then analysed by means (3, 3d, 9a, 9b, 8) of detecting the reflected light intensity, associated with processing means (10). In a slightly different embodiment, the illumination means comprise a fluorescent tube (7) that, by means of multi-directional rays (7a), illuminates all the top part of the stack (5), including the area of the aforementioned light line (T), analysed by the detection means associated with the processing means. In the present description, the analysis of a longitudinal light line (T) by the detection means (3, 3d, 9a, 9b, 8) associated with the processing means is called the longitudinal analysis of the stack (5). The analysis according to several segments of the stack (5), over its entire length, by the processing means (10) associated with the detection means is also understood as a longitudinal analysis.

The light rays (6) emitted by the light source or sources permit a longitudinal analysis of the batch products, that is to say parallel to the long side of the carton (4). The relative movement of the carton with respect to the CIS module or modules is transverse, that is to say parallel to the short side of the carton (4), and involves longitudinal analyses on different longitudinal areas. The longitudinal light line (T) is in fact moved at several levels according to the width of the stack (5). For example, 100 longitudinal analyses are performed in a outward and return reciprocating transverse movement (M4a, M3a). In a variant embodiment, different longitudinal analyses are preformed by transverse movements, not perpendicular to the longitudinal direction, of the line (T) on the stack (5). In another embodiment a fluorescent tube (7) more powerful than diodes illuminates the entire top part of the stack (5). In this case, a matrix photosensitive cell (for example of a CCD matrix, can simultaneously perform longitudinal analyses on different longitudinal areas without relative movement of the carton (4) with respect to the illumination and detection means.

A CIS module (3, 3d) or the CCD camera (8) are connected to a processing circuit in order to transmit the electrical signals issuing from the transformation of the light energy into electrical energy by the photosensitive cells. The electrical signals produced contain information for each pixel of the CIS or CCD photosensitive cell. The electrical information is generally translated into levels, digitised and stored by the storage means. The memorisation and storage phases, already contained in the patent FR 2 854 476 entitled “Device for counting stacked products” will not be described here. Each CIS or CCD photosensitive cell comprises, by way of example, 10,000 photosensitive elements for analysing the entire length of the stack (5) and enabling the counting of a batch of products with a maximum for example of 1000 products. Each photosensitive element makes it possible to detect a light signal and to express this signal in the form of an electrical signal representing at least 256 levels of brightness. This signal for 256 levels of brightness is translated into 8-bit words, each word is recorded in the memory of the device. Thus, for the given example, the memory consists of 10,000 words of one byte. In a variant embodiment, the photosensitive elements of the CIS or CCD photosensitive cells may be sensitive to rays of different colours and to their constitution by a combination of red, green and blue. In another example embodiment, the photosensitive cell is a matrix comprising for example 2000 photosensitive elements, for analysis of the length, by 2000 photosensitive elements, for analysis of the width. Simultaneous longitudinal analyses are therefore possible along several longitudinal lines (T) of the stack (5), at different distances from a long edge of the stack (5). In this case the analysis of the light rays reflected by the stack (5) is carried out in two dimensions, unlike the other embodiments in one dimension. Analysis performed in two dimensions allows several different longitudinal analyses of the stack (5), the counting device being fixed, while analysis carried out in one dimension requires a movement, for example of the stack (5), in order to effect several different longitudinal analyses.

The information representing for example the brightness level, stored in memory in digital form, is translated in the form of a graph, as illustrated by the curve (C1) in FIG. 8, and shows variations in brightness. The graph presents peaks representing maxima and hollows representing minima of the signal issuing from the electronic circuits associated with the photosensitive cells. The processing means (10) analyse these variations by for example processing all the values taken in order according to their position. For example the pixel furthest to the right is processed, and then the following one going towards the left and so on. A processing algorithm relies for example on the comparison of at least two successive values in order to determine the direction of variation of the curve.

The processing of the data representing the brightness level, stored in memory, will now be described in relation to FIGS. 1 to 6 and 7A.

The signal or signals s(n) connected by a longitudinal analysis of the stack (5) of thin products (2) are recovered by the processing means (10), which then determine the repetition of a pattern (M) representing a product by use of an algorithm for processing a de-noised signal. A Fourier filtering is carried out first in order to eliminate the hollows in the recovered signal, the noise being able to be eliminated just after for the counting signal reconstituted by an inverse Fourier transformation. The way the counting is carried out is illustrated in FIG. 1. The counting method thus comprises:
a step (51) of pre-processing of the recovered signal, including a filtering of the signal for producing a filtered signal, the filtering preferably being a filtering performed on the Fourier transform (fast or not) FFT of the signal with a comb filter;
a step (52) of estimating, in the filtered (Sf) and possibly de-noised (Sd) signal, a pattern (M1, M2) representing a thin product (2), the estimation being facilitated by using the de-noised signal (Sd) as illustrated in FIG. 3a;
a step (53) of calculating intercorrelation information between the estimated pattern and the filtered (Sf) and possibly de-noised (Sd) signal, to detect patterns (M1, M2) present in the filtered (Sf) or respectively de-noised (Sd) signal; and
a step (54) of signalling, by an interface of the device, information representing the number (N) of thin products (2) processed by the device, by counting the maxima detected in the intercorrelation information.

The method first comprises a step (50) of converting the signal, before filtering, into data representing brightness levels in correlation with a stack thickness dimension expressed in pixels. In one embodiment of the invention, the signalling step (54) comprises a display of a number of chip cards to be processed by a chip card personalisation machine and/or a transmission of the information representing this number to the personalisation machine.

The aforementioned steps (50, 51, 52, 53, 54, 55) can be performed in automated fashion on a computer connected to the detection means (8). All the signal processing operations and the calculations can be performed by a program loaded directly into the memory of the computer and specifically used to allow the counting of the number (N) of thin products (2). As illustrated in FIGS. 5A and 5B, the form of the pattern adopted for a series of products (2) being counted can be estimated after a comparison between the first periodic pattern (M1) detected in the de-noised signal and a reference pattern (Mref) stored in the storage means.

The estimation step (52) can make it possible to define the first periodic pattern (M1) representing a thin product (2) to within any phase shift, as illustrated in FIGS. 3C, 4A and 4B. Preferably, the reference pattern (Mref) is used to perform the circular adjustment illustrated in FIG. 5B, making it possible to obtain a second pattern (M2) estimated without phase shift. By way of non-limitative example, parameterising means associated with the processing means can be provided in the device in order to obtain the reference pattern (Mref) during a counting performed by the counting device with a standard batch of thin products (2). Other configuration modes for the reference pattern (Mref) can naturally be used.

To perform the intercorrelation information calculation step (53), the processing means (10) provide for example an intercorrelation signal (C2), as illustrated in FIG. 8, and means of counting patterns (M2) in the de-noised signal, by detection of the local maxima (S) of the intercorrelation signal (C2).

With reference to FIGS. 2A and 2B, the pre-processing step (51) can be performed as follows.

It is first of all necessary to consider the signal of size N acquired by the detection/acquisition machine (8): s(n), n=0 . . . N−1

The pre-processing step (51) can consist of de-noising this signal s(n) to the maximum by filtering the frequencies not corresponding to harmonics (comb filter). The filtering steps are for example as follows:

i) “Zero Padding” Method

Zeros are added at the end of the counting signal s(n) so that the number of samples N_{zp} is a power of 2 (this is necessary to calculate the FFT transform). The signal after the zero padding s_{zp} is written: S_{zp}(n)m n=0 . . . N_{zp}−1

If n<N:s_{zp}(n)−s(n)

If n≧N:s_{zp}(n)=0

Thus the recovered vector corresponds to an increased signal size and groups together an even number N_{zp} of signal samples.

ii) Calculation of the FFT

The FFT transform (Fast Fourier Transform) of the vector S_{zp} (of size N_{zp}) is a complex vector Ŝ_{zp}(n), n=0 . . . N_{zp}−1. This vector makes it possible to estimate the various frequencies contained in the signal s_{zp}.

iii) Locating the Fundamental

When a signal has strong periodicity, its FFT transform has a particular character. In FIG. 2A, which traces the modulus of Ŝ_{zp}(n), a succession of peaks of decreasing height is observed. The graph shown is produced for a thickness Ep of product (2) parameterised at 18 pixels and shows the modulus of the FFT transform as a function of standardised frequencies. The decomposition of the signal into harmonics is displayed through the various peaks. These peaks represent the periodic character of the signal. The first peak (h0) is called the fundamental (or first harmonic) and the other peaks (h₁, h₂, . . . ) are called the harmonics.

iv) Frequency Filtering

Filtering is done by truncation of the FFT transform, as illustrated in FIG. 2B. Only the frequencies around the harmonics are kept. The frequency width (p) of each bandwidth is illustrated in FIG. 2B. This frequency width is denoted 2*bₚ. The filter thus obtained forms a comb filter. The processing means (10) advantageously use this type of comb to eliminate noise by filtering and in particular the frequencies not corresponding to harmonics. The frequencies that are distant from harmonics and may correspond to differences between the thin products (2) are eliminated.

The FFT transform of the filtered signal is denoted Ŝ_{F}(n), n=0 . . . N_{zp}−1. It is therefore obtained in the following manner:

Ŝ_{F}(n)=Ŝ_{zp}(n), if min{|n−hᵢ|,I=0 . . . number . . . harmonics}≦bₚ

Ŝ_{F}(n)=0 otherwise

v) Reconstitution of the Counting Signal

To find the filtered signal from its FFT transform, an Inverse Fast Fourier Transform IFFT is applied. Then the zeros at the end of the signal are eliminated. The filtered signal thus obtained is the pre-processed signal. It is denoted x(n). The fast Fourier transform calculation algorithm and the other calculation algorithms are known per se and will not be detailed here (see for example Signal Processing Methods and Techniques, by Jacques Max and Jean-Louis Lacoume, published by Dunod, on the subject of the FFT transform).

It will be understood that the processing means (10) of the device are provided with at least one program that makes it possible to store all the intermediate results, obtained successfully during processing, for example by means of storage tables. The various calculation algorithms are respectively used by calculation modules arranged to recover the appropriate information (signal portions during processing, results of previous operations, etc).

During the frequency filtering, only some of the harmonics may be preserved. In theory, it is in fact entirely possible to count the number of thin products (2) in the signal by keeping only the fundamental (also referred to as the 0 harmonic). Let us take the case of a signal with very good contrast as illustrated in FIG. 13A (the 0 harmonic has a modulus with a value of approximately 60000, very much higher than the modulus of the other harmonics). In this case, 96% of the useful energy is concentrated in the first harmonic. A simple band-pass (or even low-pass) filtering around the fundamental suffices to harvest most of the useful information. The system for counting thin products functions very well.

Let us take a second example, that of a signal with poor contrast as illustrated in FIG. 13B (the 0 harmonic has a modulus with a value of approximately 4000 and the following harmonic a modulus of approximately 2000). In this case, the energy remains high for the first three harmonics. A comb filtering keeping at least the first three harmonics is necessary and sufficient.

In the majority of cases, a comb filtering that keeps all the harmonics may be effected. However, these two examples show that, according to circumstances, it is possible to keep less. In all cases, it is necessary to keep at least the fundamentals so that it is possible to calculate the number of thin products. A system of comparison between harmonics may be used to limit the filtering to a given number of harmonics.

The step (52) of estimating the pattern (M1) to within any phase shift will now be more particularly described in relation to FIGS. 3A, 3B and 3C.

The principle of the processing is based on the following modelling: the signal x(n) is the sum of a noise w(n) and of a useful signal y(n) composed of a repetition of patterns mot(n) representing the edge of a card.

x(n)=y(n)+w(n) (E1)

For example, if the pattern (M1) representing a card is a saw tooth as illustrated in FIG. 3C, the signals y(n) and x(n) have the trend represented by the respective traces (Sd, Sf) in FIGS. 3A and 3B. The de-noised signal trace (Sd) has an easily recognisable geometric character in the example in FIG. 3A.

In the case of a counting of chip cards or similar portable objects, the thickness of the card expressed in pixels can be denoted Ep. Its value is fixed arbitrarily at the start of the processing. The thickness can be estimated at the start of processing by means of a first FFT:
Calculation of the FFT and its modulus.
Location of the fundamental by a search for the maximum on the modulus of the FFT. In the vector Modulus, of size N, the position of the fundamental is denoted Xfonda.
The position of the fundamental correspondence to a thickness Ep expressed in pixels: Ep=N/Xfonda.

Next Ep is rounded to the closest integer value.

In the example in FIGS. 3A to 3C, the purpose of the estimation step (52) is to estimate the periodic pattern (M1) that is repeated regularly in the de-noised signal. It will be understood that a modelling of the counting signal facilitates the search for an optimum pattern in its representativeness of a card. It is thus necessary to estimate in the signal y(n) the pattern relating to the thickness (e) of a card: mot(n) for n−[0,Ep−1]. For this purpose the processing means (10) effect an estimation of the Fourier transform (FT) of the pattern:

Mot(f)=FT[mot(n)], n=[0,Ep−1] (E2)

For each frequency f, the pattern mot(f) in the Fourier domain is expressed by:

Mot(f)=Rₘ(f)e^{iθm(f)}.

The search for Mot(f) takes place in two phases:
Estimation of the modulus Rₘ(f)
Estimation of the phase θₘ(f)

Once the Fourier transform of the periodic signal portion Mot(f) is estimated for each frequency f, the pattern mot(n) will be easily calculatable by an inverse Fourier transformation.

The processing means (10) then make it possible to estimate respectively the modulus and the argument of Mot(f). For estimation of the modulus Rₘ(f) of Mot(f), the processing can consist simply of effecting the autocorrelation c(T) of the signal observed.

$$c ( τ ) = {\sum }_{n}^{ } x ( n ) x ( τ + n ) , \\ τ = [ 0 , Ep - 1 ] \qquad ( E3 )$$

The Fourier transform of equation (E3) gives the modulus of Mot(f):

$$C ( f ) = {\sum }_{n}^{N - 1} c ( τ ) {e}^{- 2 iπ k \frac{n}{N}} \\ C ( f ) = Mot ( f ) \cdot Mot ( - f ) = {R}_{m} ( f ) \qquad ( E4 )$$

As a person skilled in the art can easily appreciate, the modulus may also be found with a convolution of the signal with itself:

$$conv ( τ ) = {\sum }_{n}^{ } x ( n ) x ( τ - n ) , \\ τ = [ 0 , Ep - 1 ]$$

Concerning the estimation of the argument θₘ(f) of Mot(f), it may be clever to simplify the problem by symmetry. This is because the problem of the estimation of the Ep values θₘ(f) for f=[0,Ep−1], may be simplified by half by using the symmetry properties of the Fourier transform FT of a real sequence: θₘ(f) is an odd function and Ep-periodic.

The simplified problem is then as follows:

Estimate θₘ(f) for f=[0,N−1] with N=(Ep+1)/2 if N is odd

Ep/2+1 if N is even

To estimate the arguments θₘ(f) of the simplified problem, we use an operator that is a little more complex, called bicorrelation, and well known in mathematics, for example in the field of higher order statistics. This is an operator with two variables. Its definition is as follows:

$$b ( {τ}_{1} , {τ}_{2} ) = {\sum }_{n}^{ } x ( n ) x ( {τ}_{1} + n ) x ( {τ}_{2} + n ) \\ for \text{:} \\ {τ}_{1} = [ 0 , Ep - 1 ] \\ and \text{:} \\ {τ}_{2} = [ 0 , Ep - 1 ] \qquad ( E5 )$$

In the Fourier domain (two-dimensional FT), the Fourier transform is of the type

$${\sum }_{n = 0}^{N - 1} b ( τ 1 , τ 2 ) {e}^{- 2 iπ h \frac{n}{N}} ;$$

and the following equation becomes:

B(f₁,f₂)=Mot(f₁).Mot(f₂).Mot(−f₁−f₂) (E6)

The argument B(f₁,f₂) is denoted θ_{b}(f₁,f₂). θ_{b}(f₁,f₂) can be expressed as a function of the θₘ(f) values:

θ_{b}(f₁/f₂)=θₘ(f₁)+θₘ(f₂)−θₘ(f₁+f₂) (E7)

The above equation corresponds to one of the fundamental properties of the bicorrelation. The following documents deal more particularly with this type of property:
Higher-Order spectra analysis, A non-linear signal processing framework; Chrysostomos L. Nikias/Athina P. Petropulu
Signal processing, “Higher-order statistics for signal processing”; J L Lacoume/P O Amblare/P Comon (equation E7 being indicated on page 115 of this document).

Let us now write the equation for f₁ varying from 0 to N−1 and for f₂=1. This gives a system of N equations (linear system).

$$\begin{matrix}{Θ}_{b} ( 0 , 1 ) & = & {Θ}_{m} ( 0 ) & + & {Θ}_{m} ( 1 ) & - & {Θ}_{m} ( 1 ) \\ {Θ}_{b} ( 1 , 1 ) & = & {Θ}_{m} ( 1 ) & + & {Θ}_{m} ( 1 ) & - & {Θ}_{m} ( 2 ) \\ {Θ}_{b} ( 2 , 1 ) & = & {Θ}_{m} ( 2 ) & + & {Θ}_{m} ( 1 ) & - & {Θ}_{m} ( 3 ) \\ & & ⋮ & ⋮ & & ⋮ & \\ {Θ}_{b} ( N - 1 , 1 ) & = & {Θ}_{m} ( N - 1 ) & + & {Θ}_{m} ( 1 ) & - & {Θ}_{m} ( N )\end{matrix} \qquad ( E 8 ) 8 )$$

It should be noted here that the last equation of the above system involves θₘ(N). For reasons of oddness and periodicity of the Fourier transform of a real sequence, we have:

θₘ(N)=−θₘ(N−1) if N is odd

θₘ(N)=−θₘ(N−2) if N is even

The above system makes it possible to express Theta_{B}=[θ_{b}(0,1) . . . θ_{b}(N+1,1) as a function of Theta_{M}=θₘ(0) . . . θₘ(N−1)]. In matrix terms, the system (E8) is written in the following manner:

Theta_{B}=A.Theta_{M} (E9)

The value of the matrix A depends only on Ep. The last line of the matrix A of the system varies as a function of the parity of Ep.

Here are the matrices of the system for Ep=16 and Ep=17:

$$A ( 16 ) = \begin{matrix}1 & 0 & 0 & 0 & 0 & 0 & 0 & 0 & 0 \\ 0 & 2 & - 1 & 0 & 0 & 0 & 0 & 0 & 0 \\ 0 & 1 & 1 & - 1 & 0 & 0 & 0 & 0 & 0 \\ 0 & 1 & 0 & 1 & - 1 & 0 & 0 & 0 & 0 \\ 0 & 1 & 0 & 0 & 1 & - 1 & 0 & 0 & 0 \\ 0 & 1 & 0 & 0 & 0 & 1 & - 1 & 0 & 0 \\ 0 & 1 & 0 & 0 & 0 & 0 & 1 & - 1 & 0 \\ 0 & 1 & 0 & 0 & 0 & 0 & 0 & 1 & - 1 \\ 0 & 1 & 0 & 0 & 0 & 0 & 0 & 1 & 1\end{matrix}$$

$$A ( 17 ) = \begin{matrix}1 & 0 & 0 & 0 & 0 & 0 & 0 & 0 & 0 \\ 0 & 2 & - 1 & 0 & 0 & 0 & 0 & 0 & 0 \\ 0 & 1 & 1 & - 1 & 0 & 0 & 0 & 0 & 0 \\ 0 & 1 & 0 & 1 & - 1 & 0 & 0 & 0 & 0 \\ 0 & 1 & 0 & 0 & 1 & - 1 & 0 & 0 & 0 \\ 0 & 1 & 0 & 0 & 0 & 1 & - 1 & 0 & 0 \\ 0 & 1 & 0 & 0 & 0 & 0 & 1 & - 1 & 0 \\ 0 & 1 & 0 & 0 & 0 & 0 & 0 & 1 & - 1 \\ 0 & 1 & 0 & 0 & 0 & 0 & 0 & 0 & 2\end{matrix}$$

These matrices are always invertible, whatever the value of Ep. The matrix system described above makes it possible easily to find the values of θₘ(0) to θₘ(N−1) by the means of the following equation:

Theta_{M}=A⁻¹.Theta_{B} (E10)

The matrix A links the arguments of the bicorrelation (correlation to a higher order) to the arguments (θₘ) of the pattern. By a resolution of the system (calculation of A⁻¹, or by converting to an equivalent triangular system), θₘ is obtained in the Fourier space. Once the modulus and argument of Mot(f) are calculated, the pattern is easily derived by an inverse Fourier transform (IFT).

With reference to FIGS. 4A, 4B, 5A and 5B, the processing means (10) of the counting device make it possible to effect a circular adjustment to eliminate any phase shifts. This is because, in many cases, estimation of the pattern by the calculations described above is not yet satisfactory. By considering for example the signal illustrated in FIG. 4A, the algorithm used for seeking the pattern will give the estimation of the pattern (M1) as indicated in FIG. 4B. A phase shift is apparent. The estimation constitutes a correct estimation of the pattern (M2) to within a pure phase shift. So that the estimated pattern is correct, a reference pattern (Mref) is used. The reference pattern (Mref) can have for example the appearance shown in FIG. 5A, in the form of an inverted U (here with three segments).

An example of additional processing applied to the pattern obtained in FIG. 4B is illustrated in FIG. 5B. The adjustment can consist of applying various phase shifts to the periodic pattern (M1) reconstituted, until the pattern (M2) most resembling the reference pattern (Mref) is found. Among all the possible patterns (m), the one giving the maximum of the scalar product with the reference pattern (Mref) corresponds to the pattern of a card. This is what is shown by FIG. 5B, in which the scalar products found (from top to bottom) are respectively:

Scalar_Product(Pattern,PatternRef)=0.7

Scalar_Product(Pattern,PatternRef)=0.5

Scalar_Product(Pattern,PatternRef)=0.3

Scalar_Product(Pattern,PatternRef)=0.2

Scalar_Product(Pattern,PatternRef)=0.3

Scalar_Product(Pattern,PatternRef)=0.5

Scalar_Product(Pattern,PatternRef)=0.7

Scalar_Product(Pattern,PatternRef)=0.9

The pattern (M2) obtained after adjustment then corresponds to a correct estimation of the pattern of a thin card or similar portable object.

FIG. 6 recapitulates the processing method implemented to make it possible to estimate a trace in the signal representing a thin product (2). The signal x(n) repeatedly contains the pattern mot(n) the Fourier transform of which can be expressed in the form r(n)e^{iθ(n)}. After calculation of the modulus and of the argument of Mot(f), going back into the real domain and then circular adjustment (by determination of a maximum of scalar product with the reference pattern (Mref)), the pattern (M2) modelled by mot(n) is obtained. Once the pattern is estimated, counting is done by calculating the intercorrelation I(n) between the estimated pattern mot(k) (of size Ep and the de-noised signal x(k) (of size N). This step, also called adapted filter, is performed thus:

### For

$$n = [ \frac{Ep}{2} … N - \frac{Ep}{2} ] \text{:}$$

$$I ( n ) = {\sum }_{k = 0}^{k = Ep - 1} mot ( k ) \cdot x ( n - \frac{Ep}{2} + k )$$

The counting is done by detecting the local maxima (S) or tops of the intercorrelation signal (C2), as indicated in FIG. 8. Having a pre-processed signal x(k) makes it possible to establish an exact count, without any risk of error relating to a small intermediate space between two consecution products (2).

In an example embodiment, FIG. 7A, the device is composed of a CIS module (3) projecting a beam of light rays (6). The light rays (6) are projected onto the stack (5) of thin elements (2), contained in the carton (4), in a longitudinal direction, forming a light line (T) on the stack (5). In another example embodiment (not shown), the device can comprise three CIS modules combined so that the light rays and the modules 3a, 3b, 3c cover the entire length of the stack (5). The CIS modules are for example placed so that part of the processed areas overlap. In addition the modules can be inclined so that the illuminate areas are aligned. Two of the modules can be inclined by an acute angle determined with respect to the vertical and the other module can be inclined by an acute angle with respect to the vertical. In this case, the modules are inclined so that the intersection of the flat light beams with the stack (5) forms only one light line (T).

In a variant embodiment not shown, the CIS modules are not inclined, the longitudinal analysis being performed in accordance with two segments, the sum of the lengths of which is at least equal to that of the stack (5). An initialisation phase determines the relative positions of the CIS modules.

In another example embodiment, FIG. 7B, the device comprises only one CIS module (3d), which moves relative to the stack (5) in several positions (PO1, PO2, PO3) in a longitudinal direction. This module (3d) runs over the entire length of the stack (5) after several movements and several stoppages at given positions (PO1, PO2, PO3) in order, on each occasion, to process an additional area (ZO1, ZO2, ZO3) of the stack (5). The various positions (PO1, PO2, PO3) are chosen so that each area partly overlaps the adjacent area. The processing means identify the signals corresponding to the overlap and eliminate the duplicated signal part. A sampling step concerning the overlap areas is also described in the patent FR 2 854 476 in order to effectively process the duplicate data.

In FIG. 7A and in the variants with three modules 3a, 3b, 3c, the relative movement of the CIS module or modules (3) with respect to the carton (4) is achieved, according to one embodiment, by a transverse movement (M4a) of the carton, with respect to the longitudinal direction of the illumination, the module or modules (3) being fixed. In another embodiment, the same relative movement is effected by a transverse movement (M3a) of the CIS module or modules (3), the carton (4) being fixed. In the example embodiment in FIG. 7B, the relative movements are done in a transverse or longitudinal direction. A longitudinal relative movement is performed parallel to the longitudinal illumination in order to position the CIS module (3d) above the various areas of the carton (4), this movement (M4b, or respectively (M3b) being performed either by moving the carton (4), the CIS module (3d) being fixed, or by moving the CIS module (3d), the carton (4) being fixed. Once in position (PO1, PO2, PO3), any relative transverse movement (M3a or respectively M4a) of the CIS module (3d) with respect to the carton (4) is effected for example perpendicular to the longitudinal illumination. In all cases, the relative transverse movements (M3a) or respectively (M4a) of the module or modules (with respect to the carton (4) involves several longitudinal analyses on various longitudinal areas of the stack (5).

FIGS. 9, 10 and 12 illustrate the use of a camera (8), for example of the matrix or linear CCD type. The CCD camera (8) is associated non-limitatively with two mirrors (9a, 9b) and an illumination means (7). This type of device is detailed in the patent FR 2 718 550. The photosensitive sensor is for example linear and allows longitudinal analysis along a line (T). The associated illumination means are for example a fluorescent tube or diodes the light rays of which are focused or not. Several longitudinal analyses are for example performed, along the same line (T) with different illumination intensities.

In a variant embodiment, several longitudinal analyses are for example carried out, along different lines (T1, T2, T3), by a relative movement of the stack (5) with respect to the CCD camera (8) and the illumination device. The illumination means (7) is for example implemented by diodes, the rays of which are, according to a non-limitative example, focused by an optical device, and requires relative transverse movements in order to carry out several different longitudinal analyses.

Where the illumination means is implemented by a fluorescent tube (7), the entire top surface of the stack (5) is illuminated, but with different intensities. The area closest to the tube is illuminated at a light intensity greater than that of the areas further away. This type of illumination with variable intensities is combined or not with relative transverse movements in order to carry out different longitudinal analyses along different longitudinal lines (T1, T2, T3), with different light intensities. A variant comprises the variation of the light intensity obtained by controlling the illumination means, at a variable power.

In the case of a relative movement, either the detection means (8, 9a, 9b) are fixed and the carton (4) is movable (M4a), or the carton (4) is fixed and the detection means (9a, 9b, 8) are movable at least partly, the mirrors (9a, 9b) and/or the CCD camera (8) being movable.

In another embodiment, the photosensitive sensor of the CCD camera (8) is of the matrix type. This type of photosensitive sensor allows analysis in two dimensions, along the length and width of the stack (5). In the case of a matrix photosensitive sensor, the transverse movements are not necessary for carrying out several longitudinal analyses. The CCD camera (8) analyses for example the entire length of the stack (5), as shown in FIG. 9, where the stack (5) is analysed over its entire length with a longitudinal movement (M8) of the CCD camera (8). Several lines, covering the entire length of the stack (5), are analysed, the lines being very close, or even up against each other, at a distance for example of 5/100 of a centimetre or further away at a distance for example of one or more millimetres. The lines (T, T1, T2, T3) analysed are also illuminated at different light intensities.

The thin elements or products (2) are stacked in a carton (4) and are fixed so as to present the long edge towards the top of the carton (4). The products (2) to be counted are disposed side by side, non-limitatively a front face of a product against a rear face of another product. FIGS. 7 to 11 show a view of thin products (2) stacked side by side, the carton (4) being shown under the stack (5). The thin products (2) are therefore placed on their edge, oriented transversely in the carton (4), that is to say parallel to the small sides of the rectangular carton (4). In the example of a personalisation card, a stack contains up to 500 cards. The counting device detects the edge of each product (2) and thus determines the number (N) of products. An example of data processing is the detection of the variation in brightness. In FIG. 8, the data translated in the form of a graph represent the brightness according to the position. In this example, a maximum will be the value of an electrical signal corresponding to a light signal received of high intensity compared with the adjacent signals. Likewise a minimum will be the value of an electrical signal corresponding to a received light signal of low intensity compared with the adjacent signals. Non-limitatively, a maximum can be interpreted, by the processing program, as the middle of a product to be counted and a minimum is interpreted as the junction of two products (2) to be counted. The junction between two thin products (2) is in fact darker and the middle of a thin element is lighter.

After the processing of the data, the counting device can indicate the number of thin products (2) in a series. By virtue of the storage of information supplied by the operator, concerning the nature of the product (2), the device associates with each series the nature of the products. Thus, in the remainder of the processing of the stack, another processing system downstream of the processing chain receives data specifying the nature of each product (2) and can therefore determine the personalisation or the checks to be made. The downstream processing system communicates with the processing means of the counting device by communication means, in a known fashion. The communication means comprise for example a cabled or infrared or radio wave connection and communication interfaces adapted to the type of connection. According to a variant, the communication means are media, such as diskettes or disks, associated with readers for these media. The type of personalisation to be effected is also taken into account. This processing is therefore done automatically, directly by inserting the carton or magazine containing the stack (5) into the processing system, or transferring the stack (5) into another support. A check can be made by comparing the number (N) found by the device for the products in the complete stack (5), with a number of products provided by a device for managing series of products (2).

The number of products (2) in each series is therefore derived according to these results. The operator knows the nature of each small series making up the stack and thus determines the nature of each product (2) at a given position. Where the thin products (2) in the stack all have the same format and are processed by a personalisation machine, the entire stack can be processed directly, additional information on the nature of the series advantageously being able to be supplied to the personalisation machine. The personalisation machine will have processed in total N elements, the processing carried out depending on their position in the stack (5).

A variant embodiment, as shown in FIG. 11, comprises at least one transverse CIS module (3t) effecting a transverse illumination, for example perpendicular to the longitudinal direction of the stack (5). The transverse CIS module (3t) comprises detection means and means of illuminating in a transverse flat beam that illuminates the stack (5) transversely. The transverse CIS module (3t) placed opposite the stack (5) analyses the transverse linear area illuminated. The analysis of the entire length of the stack (5) is achieved by a movement (M3t) of the transverse module, in the longitudinal direction of the stack (5). The longitudinal movement (M3t) of the transverse CIS module (3t) is carried out a given speed. The photosensitive cells of the transverse module transform the light energy of the rays reflected by the stack (5) and focused on to photosensitive cells of the detection means into electrical signals that are the image of the light intensity. The processing means of the counting device sample these signals and convert the analogue values of the electrical signals into computer codes that are images of these analogue values, placed in the storage means. When the transverse CIS module has covered an area comprising the entire length of the stack (5) with its illumination means associated with its detection means, the stack (5) has been analysed over its entire length and over an area of given width. The two-dimensional analysis thus makes it possible to carry out several longitudinal analyses on the stack (5). The longitudinal analyses are performed along lines that are close (T1, T2) or distant (T1, T3) by several millimetres.

It should be obvious for persons skilled in the art that the present invention allows embodiments in numerous other specific forms without departing from the scope of the invention as claimed.

### APPENDIX

### Fourier Transform (FT)

The Fourier transform of the signal (real or complex) s(n), n=0 . . . N−1 is denoted Ŝ(n), n=0 . . . N−1. It is obtained by the following equation:

$$\hat{S} ( n ) = {\sum }_{k = 0}^{N - 1} s ( k ) exp ( - 2 πj nk / N )$$

This transformation makes it possible to evaluate the frequency content of a signal.

### Fast Fourier Transform (FFT)

An algorithm for calculating the Fourier transform of a signal more rapidly was developed by Cooley and Tuckey in 1965. This processing is faster, but functions only if the size of the signal is a power of 2. This algorithm is called a fast Fourier transform.

### Inverse Fourier Transform (IFT)

This transformation makes it possible to find a signal s(n) from its Fourier transform Ŝ(n). Its formula is as follows:

$$s ( n ) = {\sum }_{k = 0}^{N - 1} \hat{S} ( k ) exp ( 2 πj nk / N )$$

### Inverse Fast Fourier Transform (IFFT)

As with the simple Fourier transform, there exists a fast algorithm for calculating the inverse Fourier transform.

Two-Dimensional Fourier Transform (FT2D)

That is to say a two-dimensional signal s(m,n) m=0 . . . M−1
n=0 . . . N−1,

There exists a definition of the Fourier transform for this signal:

$$\hat{S} ( m , n ) = {\sum }_{k = 0}^{M - 1} {\sum }_{l = 0}^{N - 1} s ( k , l ) exp ( \frac{- 2 πj ( mk + nl}{MN} )$$

As for a 1-D signal, fast and inverse transforms associated with this transformation can be defined.

1. Device for counting series of thin products, stacked side by side, in a given direction in a holding means, the stacked thin products all having identical thicknesses and constituting a stack, the device comprising:
a means of illuminating the stack producing one or more light beams covering at least the entire length of the stack,
a detection means comprising at least one detection circuit, comprising a plurality of photosensitive elements, and at least one optical device associated with the detection circuit, for focusing light rays reflected by the stack,
storage means,
processing means receiving signals coming from the at least one detection circuit and configured to extract from the received signals brightness levels in correlation with a dimension along the stacking axis expressed in pixels, the processing means configured to generate a given signal corresponding to the signals received and including:
extraction means for extracting, from the given signal, a pattern representing a thin product; and
calculation means for calculating the number of thin products, by an intercorrelation of the given signal with the extracted pattern, in order to determine an intercorrelation signal corresponding to the number of patterns present and corresponding to the number of thin products in the stack.

2. Device according to claim 1, wherein the processing means further comprise:
pre-processing means for effecting a Fourier transform for supplying from the received signals a transformed signal revealing harmonics and for then determining the characteristics of a filtering means for filtering the transformed signal with preservation of at least one harmonic;
said given signal being a filtered signal resulting from the pre-processing.

3. Device according to claim 2, wherein the pre-processing means comprise reconstitution means effecting an inverse Fourier transform on a filtered transformed signal supplied by said filtering means in order to deliver a pre-processed signal corresponding to the given signal.

4. Device according to claim 3, wherein the extraction means are arranged to extract the pattern representing a thin product in the pre-processed signal.

5. Device according to claim 3, wherein the means of extracting a pattern comprise:
means of parameterising the thickness determining the first harmonic in the Fourier transform of the signals received and the corresponding thickness of the product,
first calculation means for firstly effecting correlation or convolution functions on the pre-processed signal initially, and then secondly a Fourier transform calculation for secondly estimating, for each of the frequencies of the Fourier domain, the modulus and argument of the Fourier transform of the pattern representing the periodic signal position corresponding to a thin product; and
second calculation means using an inverse Fourier transformation for calculating said first pattern from results obtained by the first calculation means.

6. Device according to claim 5, wherein the first calculation means effect an autocorrelation function c(T) of the filtered signal, defined by the formula:
$$c ( τ ) = {\sum }_{n}^{ } x ( n ) x ( τ + n ) , \\ τ = [ 0 , Ep - 1 ]$$
where N is the number of pixels of the image of the filtered signal, x(n), n=[0 . . . N−1] is the filtered signal and Ep is the thickness of a thin product expressed in pixels.

7. Device according to claim 5, wherein the first calculation means effect a convolution function conv(T) of the filtered signal on itself, defined by the formula:
$$conv ( τ ) = {\sum }_{n}^{ } x ( n ) x ( τ - n ) , \\ τ = [ 0 , Ep - 1 ]$$
where n is the number of pixels of the image of the filtered signal, x(n) is the filtered signal and Ep is the thickness of a thin product expressed in pixels.

8. Device according to claim 6, wherein the first calculation means is arranged to calculate the Fourier transform of the autocorrelation function c(T) of the filtered signal, in order to determine the modulus of the Fourier transform of the periodic signal portion.

9. Device according to claim 5, wherein the means of parameterising the thickness of the thin products determine the thickness in pixels and the first calculation means make, for a first half of the frequencies of the plurality of frequencies, in order to determine the argument of the Fourier transform of the periodic signal portion, an estimation of the values of the argument functions θₘ(f) for f=[0,N−1] with N=(Ep+1)/2 if N is odd or N=Ep/2+1 if N is even,
where θₘ(f) is an odd function and Ep-periodic, Ep being the thickness of a thin product expressed in pixels;
this estimation being performed by n-correlation means of order greater than 2 arranged to:
use a 2-variable operator defined as follows:
$$b ( {τ}_{1} , {τ}_{2} ) = {\sum }_{n}^{ } x ( n ) x ( {τ}_{1} + n ) x ( {τ}_{2} + n )$$
$$for$$
$${τ}_{1} = [ 0 , Ep - 1 ]$$
$$and$$
$${τ}_{2} = [ 0 , Ep - 1 ]$$
where n is the number of pixels of the image of the filtered signal and x(n) is the filtered signal;
calculate the Fourier transform of the n-correlation function b(T1, T2) in the Fourier domain, via a two-dimensional Fourier transformation, in order to obtain a matrix set of linear equations expressing the arguments of the n-correlation function as a function of the arguments of the pattern in the Fourier frequency domain; and
invert the system in order to take the argument of the n-correlation back to the argument of the pattern in the Fourier domain.

10. Device according to claim 9, wherein the means of parameterising the thickness comprise means of estimating the thickness Ep by means of a first fast Fourier transformation FFT, the estimation means performing:
a calculation of the FFT and its modulus;
location of the fundamental by a search for a maximum on the modulus of the FFT, while in the vector Modulus, of size N, the position of the fundamental is denoted Xfonda;
a calculation of the thickness Ep, taking into account the fact that the position of the fundamental corresponds to a thickness Ep expressed in pixels: Ep=N/Xfonda; and
a rounding of the value found for Ep to the closest integer value.

11. Device according to claim 5, wherein filtering means are provided for supplying to the extraction means a filtered de-noised signal, the second calculation means operable to determine a first periodic pattern representing a thin product to within any phase shift.

12. Device according to claim 11, wherein the extraction means execute at least one algorithm for processing the de-noised signal in order to determine the signal pattern used for the intercorrelation, the form of the pattern adopted for a series of products being counted being estimated after a comparison between the first periodic pattern detected in the de-noised signal and a reference pattern stored in the storage means.

13. Device according to claim 12, where in the parameterising means associated with the processing means are designed to store the reference pattern during a counting effected by the counting device with a standard batch of thin products.

14. Device according to claim 1, wherein the filtering means is a comb filter configured to eliminate by filtering, in the received signals, noise and frequencies that do not correspond to harmonics, in order to obtain a pre-processed signal in which frequencies that are distant from the harmonics and potentially corresponding to gaps or spaces between the thin products are eliminated.

15. Device according to claim 5, in which the means of extracting the signal pattern comprise circular adjustment means for avoiding obtaining a pattern offset by phase shift, the circular adjustment means reproducing, from the first pattern, patterns with different phase shifts, the phase shift value applied being determined by the use of a reference pattern.

16. Device according to claim 5, wherein the means of calculating the number of thin products comprise:
means of calculating intercorrelation between the extracted signal pattern and the de-noised signal, making it possible to supply the intercorrelation signal; and
means of counting the patterns in the de-noised signal, by detection of the local maxima of the intercorrelation signal.

17. Device according to claim 15, wherein the circular adjustment means comprise:
means of determining, from the first pattern, patterns with different phase shifts;
means of calculating a scalar product used to calculate for the different patterns scalar products with the reference pattern; and
comparison means for determining a maximum among the calculated scalar products, the phase shift finally applied corresponding to the one maximising the scalar product with the reference pattern.

18. Device according to claim 1, wherein the processing means generate a vector representing the signals received and effecting a fast Fourier transformation on this vector, the filtering means receiving the fast Fourier transform of this vector and effecting a frequency Fourier filtering after a determination of the harmonics.

19. Device according to claim 18, wherein said vector is generated by a program executing a zero-padding method so that said vector corresponds to an increased signal size and groups together a number N_{zp} of signal samples, N_{zp} being a power of 2, the program being provided with an added-zero suppression function, this suppression function being activated to make it possible to obtain the filtered signal after application of the inverse fast Fourier transform.

20. Device according to claim 16, wherein the intercorrelation calculation means calculate the correlation I(n) between the estimated pattern mot(k) of size Ep, and the de-noised signal of size N, by use of the following formula:
for:
$$n = [ \frac{Ep}{2} … N - \frac{Ep}{2} ] \text{:}$$
$$I ( n ) = {\sum }_{k = 0}^{k = Ep - 1} mot ( k ) \cdot x ( n - \frac{Ep}{2} + k )$$
where n is the number of pixels in the image of the de-noised signal, x(k) the de-noised signal and Ep is the thickness of a thin product expressed in pixels.

21. Device according to claim 1, wherein a CIS module disposed longitudinally and opposite the stack constitutes the illumination means and the detection means, the CIS module having a length at least equal to that of the stack, or the CIS module effecting movements in the longitudinal direction of the stack facing a zone covering at least the entire length of the stack in several steps.

22. Device according to claim 1, comprising a plurality of CIS modules, disposed longitudinally and opposite the stack, each CIS module comprising detection means and means of illumination by a flat beam in the given direction, the sum of the lengths of the CIS modules being at least equal to the length of the stack.

23. Device according to claim 22, in which the CIS modules illuminate the stack along an illumination line, each CIS module being inclined at a given angle so that its planar illumination beam encounters this line.

24. Use of the device according to claim 1, wherein information is transmitted, via communication means, by the processing means to a processing system, of the personalisation machine type, downstream of a processing chain, the information transmitted comprising the number of thin products calculated by the device for each series constituting the stack and/or information for deriving this number and/or an identifier associated with each series.

25. Use according to claim 24, wherein the processing system personalises the products in the series, physical or software personalisation operations to be applied to each element in a series being associated with the information transmitted by the processing means.

26. Use of the counting device according to claim 1, characterised in that a logic personalisation station, processing a series of thin products comprising an integrated circuit, enables personalisation information for the use for which the product is intended to be entered in the memory of the integrated circuit.

27. Method of processing at least one signal coming from the detection circuit or circuits of a thin product counting device according to the preamble of claim 1, the method comprising:
a step of pre-processing said signal, including a filtering of the signal to produce a filtered signal;
a step of estimating in the filtered signal a pattern representing a thin product;
a step of calculating intercorrelation information between the estimated pattern and the filtered signal, in order to detect patterns present in the filtered signal; and
a step of signalling, by an interface of the device, information representing the number of thin products processed by the device, by counting the maxima detected in the intercorrelation information.

28. Method according to claim 27, wherein the filtering during the step of pre-processing said signal is performed after a Fourier transformation and by the use of a comb filter.

29. Method according to claim 27, comprising a step of converting the signal, before filtering, into data representing brightness levels in correlation with a stack thickness dimension expressed in pixels, the estimation step defining a first periodic pattern representing a thin product to within a potential phase shift, and then using a reference pattern for effecting a circular adjustment for obtaining a second estimated pattern without phase shift.

30. Method according to claim 26, wherein the signalling step comprises a display of a number of chip cards to be processed by a chip card personalisation machine and/or a transmission of information representing this number to the personalisation machine.

31. Computer program directly loadable into the memory of a computer and including computer codes for controlling the steps in claim 27 when said program is executed on a computer, said program thus enabling series of thin products in a stack to be counted.
